(19) United States
(12) Patent Application Publication
(10) Pub. No.: US 2007/0066113 A1
(43) Pub. Date: Mar. 22, 2007

(54) Insulating panel, manufacturing process and use

(75) Inventor: Marc Gansemans, Rhode-Saint-Genese (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: SOLVAY (SOCIETE ANONYME), Brussels (BE)

(21) Appl. No.: 10/574,288

(22) PCT Filed: Oct. 1, 2004
(86) PCT No.: PCT/EP04/52407

§ 371 Date: Mar. 31, 2006

(30) Foreign Application Priority Data
Oct. 3, 2003 (FR) 03.11592

(51) Int. Cl. H01R 13/64

(52) U.S. Cl. 439/248

(57) ABSTRACT

An insulating panel including an integrated assembly system allowing the panel and at least one other complementary panel to be assembled in at least one dimension in space. The panel and its assembly system are of a form that, when the panel and complementary panel are assembled, they delimit with their assembly system at least one cavity suitable for housing a seal, the cavity widening at least partly towards the inside of the panel.

The invention concerns insulating panels of given form, a manufacturing process for such panels and their use.

Many sectors of economic activity require insulating panels produced at low cost. For example, thermal insulation properties of panels used for roofing or for various partitions are essential in the building and civil engineering sectors. The same applies to the transport, refrigeration and other sectors. It is known to integrate an assembly system into these panels in order to allow them to be assembled with a similar complementary panel.

In numerous situations (in the vicinity of motorways, airports, noisy machinery, etc.), acoustic insulation properties are sought in addition to thermal properties. A known method of maximising these properties is to insert a seal (or several seals) between two complementary panels during their assembly. However, a drawback frequently encountered with such a system involves deterioration and/or tearing of the seal during use and especially during cleaning of the assembled structure, for example by high-pressure cleaning.

The present invention is specifically aimed at overcoming this drawback of systems of the prior art, by providing insulating panels fitted with a reliable, watertight, quick and simple assembly system, resistant to the different cleaning methods used and, in particular, to high-pressure cleaning. Moreover, these panels are easy to manufacture and assemble.

Accordingly, the invention concerns an insulating panel including an integrated assembly system allowing the said panel and at least one complementary panel to be assembled in at least one dimension in space, the said panel and its assembly system being of a form that, when the said panel and complementary panel are assembled, they delimit with their assembly system at least one cavity suitable for housing a seal, the said cavity widening at least partly towards the inside of the panel.

The panels according to the present invention are essentially flat. The word “essentially” refers particularly to cases in which the panels have a textured surface. Depending on the implementation methods, the panels may be somewhat flexible, allowing them to be bent when used.

The surface of the insulating panel according to the invention may feature different textures. This texturing can comprise well-known forms of corrugation (rounded, greca-shaped, etc.) or any periodic shape obtainable by hot-forming techniques. It is effectively known that such texturing increases the rigidity of the whole panel. In the case of multilayer panels, every combination of this texturing is possible for the different layers and, in particular, for the external layers. For example, two greca-shaped corrugations or one greca-shaped corrugation and one thermoformed textured surface can therefore be combined. It is also possible to use layers with a flat external surface and a textured, for example ribbed, internal surface or even the reverse configuration.

The panels according to the invention are mainly (i.e. predominantly by weight) made of insulating material(s) such as wood, plastics, etc., which does not exclude a part of these panels being made of non-insulating material such as metal, for example. Preferably, however, the panels according to the invention are mainly made of plastic. It is most particularly preferable that the panels according to the invention are multilayer panels with an expanded plastic core incorporated between two layers of non-expanded material, which may be plastic, wood and/or metal. Preferably, the external layers are either both made of non-expanded plastic or one is made of non-expanded plastic and the other is made of a metal such as steel, aluminium, etc.

Selection of a panel with an expanded core is particularly preferred as it enables, in particular, a light, flexible, easy-to-assemble structure to be obtained. A panel with a cellular (“honeycomb”) core, which also provides this lightness/flexibility, can be equally or alternatively envisaged.

By “expanded” plastic is meant a plastic whose density has been reduced by the inclusion of additives known as “foaming agents”. Such additives are well known in plastics technology. They can be of various types and are often grouped into two families: chemical foaming agents and physical foaming agents. They can also be mixed. Information on this subject can be found in many technical publications. The density reductions vary widely according to the foaming agent and the quantity used. A very suitable plastic is one whose density has been reduced by more than 5%, even by more than 10%, with respect to its value without foaming agents under identical temperature and pressure conditions.

By “non-expanded” plastic is meant a plastic whose density is close to its value without foaming agents under identical temperature and pressure conditions. It may or may not contain foaming agents but, when it does, the quantity thereof must be small or it is necessary for the foaming agent action to have been prevented, for example by applying pressure. A very suitable plastic is one whose density has been reduced by less than 5%, or possibly even by less than 10%, with respect to its value without foaming agents under identical temperature and pressure conditions.

In the multilayer panels according to this alternative embodiment of the invention, the transition between the expanded layer and the non-expanded layer may be sudden, in other words there is a direct change from the expanded plastic density to the non-expanded plastic density. Depending on the manufacturing technique used, the transition may also be more gradual and feature an intermediate density zone. This will often be the case when both the expanded and non-expanded layers are made of the same material, the material expansion being limited to the expanded layer due to the implementation conditions.

A wide range of plastics is currently available for making foams: polyethylene, polypropylene, polyvinylidene fluoride, polyurethane. Polyurethane foam is preferred because of its qualities of adherence to many substrates (plastics, metals, wood, etc.), its ease of implementation and its moderate cost.

The layers of non-expanded material, when they are polymeric, can be made of polyethylene, polypropylene or PVC, to mention only what are called commodity polymers. PVC is nevertheless preferred in view of its extensive use particularly in the building sector and for which there are grades with good resistance to fire, to weathering and to solar radiation. Flexible or rigid PVC can be used depending on circumstances. These two materials can also be very advantageously combined, a non-expanded layer being made of flexible PVC and the other being made of rigid PVC. Use of flexible PVC for the external layer (the layer that is exposed to the weather) permits exploitation of the renovation possibilities offered by flexible PVC membranes. The whole panel would not need to be replaced during renovation. Covering it with a new membrane layer using well-known techniques for these products would be enough.

The rigid PVC layer placed on the inside of the panel ensures good panel rigidity.

In a preferred method of implementation for multilayer insulating panels according to this embodiment of the invention, the expanded plastic core is made of polyurethane and the two layers of non-expanded material are made of flexible PVC and/or rigid PVC and/or metal. Preferably, rigid PVC is used for both layers. Selection of such materials allows panels according to the invention to be easily manufactured and, in particular, their external layers to be easily folded (see details of preferred processes hereafter).

According to circumstances, an adhesive may be required to ensure adhesion between the different panel layers, if need be. It can form a separate layer between the expanded and non-expanded layers or else be an integral part of these layers. Alternatively, as explained hereafter, an injected/foamed (expanded) plastic core can ensure adherence between the different panel components when this is used. In particular, this core can be advantageously injected between the other panel components (external layers, assembly system) after these have been suitably preset using a jig (see hereafter).

In this alternative embodiment of the invention, the non-expanded layers of the panel may or may not be reinforced by any well-known technique (for example glass or polyester fibres or fabrics). They can include any type of additive, well known in plastics technology, for improving certain properties (such as impact resistance, fire resistance, etc). They may also have been subjected to surface treatment or even have been coated or covered with external layers, for example thin protective layers, in particular solar radiation protection coatings. Alternatively, in a preferred embodiment, at least one of these layers is based on an oriented plastic, and in particular a biaxially oriented plastic. Two external layers made of biaxially oriented plastic give good results in certain applications. The purpose of these thin layers may also be decorative.

According to the invention, the panels feature an integrated assembly system. This means that the parts constituting the system are already incorporated in the panel before it is fixed to other panels. Additional separate parts are therefore unnecessary and assembly can thus be rapid and simple.

The integrated assembly system can, for example, be made of metal (aluminium in particular), plastic, etc. Plastics are preferred. Given the low thermal conductivity of these materials, heat bridges are thereby effectively avoided. Indeed, in the thermal insulation field, it is well known that one, even small, structural component with a high thermal conductivity can degrade the insulation properties of the whole structure.

The assembly system according to the invention is generally made up of two complementary sections, which are either “male” and “female” type sections or two identical sections shaped such that they interlock. This latter alternative embodiment is preferred because, in particular, it allows panel manufacturing costs to be reduced. Sections with a general “S” shape are very suitable. This type of section, in particular associated with an expanded core panel, in fact provides a degree of assembly flexibility (torsion possible between sections when assembling panels).

In general, any type of section shaped such that two complementary sections, when assembled, are interdependent over a large part of their surface area (excluding obviously the place forming the cavity intended for the seal) is suitable. Thus, the shape of these sections is preferably such that they are interdependent over at least ½ and even over at least ¾ of their surface area. As a result, the depth of each cavity (delimited by this system with a complementary panel and its assembly system) does not exceed preferably ¼, even ⅙, or most particularly ⅛, of the panel depth.

Most complementary panels are preferably similar. However, in certain applications, it may turn out to be useful to produce “exceptional” complementary panels featuring only one of the two parts at just one or both of their ends. Some panels may even include complementary parts of the assembly system at more than two of their ends. The complementary panels may also be corner, edge or connecting panels. For the sake of simplicity, it will be understood that reference is hereafter made to a panel featuring two complementary parts of the assembly system at two of their opposing ends.

In a preferred alternative embodiment, the panel assembly system according to the invention comprises two identical plastic sections located on either side of the panel in a lengthwise direction. In this alternative embodiment of the invention, “identical” sections mean separate sections of identical shape and such that they are interlockable and capable of delimiting the cavity according to the invention, in conjunction with the panels. By panel “length” is meant the dimension parallel to the leaf and section extrusion direction. By “interlockable” is meant “capable of being made interdependent over a large part of their surface area” as previously described. The aim is to create cavities whose size is exactly suited (equal) to that of the seals intended for inclusion therein, preferably by instantaneous injection of material. This sealing method is effectively highly practical and efficient.

The notion of section is well known in engineering (parts geometrically defined by translating a 2-dimensional outline). However, according to the invention, the sections can possibly also include additional periodic patterns such as notches or protuberances (reinforcing ribs for example) arranged at regular spacing along the section. The section can comprise a part produced separately from other panel components and assembled during panel manufacturing. It can also comprise the ends of the non-expanded material layers.

The panels according to the invention are intended for assembly in at least one dimension in space. The word “dimension” is here meant in the geometrical sense, namely pairs of perpendicular directions: a plane has two dimensions and a space has three dimensions. When the panels are assembled in one dimension, this dimension is that perpendicular to the panels. When the panels are assembled in two dimensions, these dimensions are the dimension perpendicular to the panels and the dimension perpendicular to the assembly system. The panels are then assembled such that they can neither be separated one from the other, nor raised with respect to each other in the dimension perpendicular to the plane of the panels.

In an alternative embodiment of the invention, the sections are groove- or rib-shaped and feature a self-tightening cam, in other words a device that prevents the panels from separating when assembled, but nevertheless so designed to allow the panels to be disassembled if necessary. One end of the panel features the rib (the “male” side), whilst the opposite end features the groove (the “female” side). Penetration of the rib into the groove assembles the panels in the dimension perpendicular to them. The self-tightening cam prevents separation of the panels when assembled, either simply by its shape or by the fact that it features a reversible clipping device. The latter alternative embodiment is preferred.

In an alternative implementation of the invention, the integrated system allows the said panel and at least one other complementary panel to be assembled in the three dimensions in space. When the assembly system comprises sections featuring grooves, ribs and self-tightening cams, assembly is achieved in the third dimension by providing the sections with the abovementioned additional periodic patterns.

In another alternative embodiment, preferred for its simplicity, the integrated system only allows assembly in one dimension in space and, if necessary, other means ensure overall assembly of a three-dimensional structure made from panels according to the invention.

According to the invention, the ends of the panels are shaped such that, when two complementary panels are assembled, they delimit with their assembly system at least one cavity suitable for housing a seal. This cavity is preferably adjustable, in other words its size can be adapted not only during panel manufacturing, but also during assembly of complementary panels (see hereafter).

All shapes of cavity with at least one part widening towards the inside of the panel are suitable according to the invention. Cavities of generally trapezoidal shape are particularly suitable. In this way, the seal cannot be removed from its location, in particular by the action of a high-pressure jet applied to the panels for cleaning purposes, for example. By “trapezoidal” cavity is meant a cavity whose side walls describe, along with the perpendiculars to the panel surface around the periphery of the cavity, a non-zero angle preferably greater than or equal to 5°, even 10° and even up to 20°. Assembly of two complementary panels, according to the invention, leads to the formation of at least one such cavity. Preferably, it leads to the formation of two such cavities, one on each panel face. Moreover and in general, the panels and their assembly systems delimit preferably, according to the invention, at least two cavities, one on each panel assembly face. In general, the seals used are such that they mate with the walls of the cavity or cavities and in such a way that, in particular, they mate substantially with the whole cavity so as to leave (virtually) no voids. This approach leads to an assembled structure that is particularly well sealed and insulating. In practice, it is easier to implement by instantaneous injection of the material forming the seal in the cavity than by using preformed seals.

The invention also concerns a process for manufacturing an insulating panel according to the invention as defined hereabove, according to which an insulating panel of suitable shape is manufactured and that an assembly system, also of suitable shape, is fixed to this panel to obtain at least one cavity widening towards the inside of the panel once the said panel is assembled with a complementary panel.

Many methods well known in plastics technology (extrusion, injection moulding, etc.), joinery (machining, etc.) and/or metallurgy (rolling, etc.) are suited to manufacturing the panel.

For example, when the panel is made of plastic, it may have been extruded directly in one piece using an extrusion (for single layer panels) or coextrusion (for multilayer panels) die, whose various segments are fed with the various materials required (expanded, non-expanded, etc.). In this case, the extruded product must be cut periodically at the die exit and possibly machined and/or thermoformed at its ends. However, this stage is difficult if very high-finish panels are sought.

Moreover, in a preferred alternative implementation of the process according to the invention, the plastic forming the panel core is injected. Particularly preferably, it is injected/foamed (expanded). If the panel is made of a single material, well-known “structured foam” techniques can be advantageously used. The abovementioned situation, in which the interface between the expanded and non-expanded layers is of a “gradual” type, then exists. In this connection, several well-known implementation methods are available for releasing the action of the foaming agent contained in the material only within the desired panel layer. The various panel layers can also be co-injected.

If the non-expanded plastic layers are produced separately, the assembly system sections can also be produced as separate parts or, on the contrary, they can be produced from one part with the non-expanded material layers (for example, by (duplicate) moulding or thermoforming their ends). Whatever the envisaged solution, it is important that the shape of the panel and/or of the assembly system be such that at least one cavity (preferably two), as previously defined, is obtained once two complementary panels have been assembled.

Thus, in a preferred alternative implementation, the panel manufacturing process according to the invention includes the following stages:
two non-expanded plastic or metal leaves are manufactured along with two complementary plastic sections of the same length as the leaves (and the panel), featuring a folded section at each of their ends
two ends of the two leaves (those parallel to the panel length) are folded in such a way as to obtain an acute angle between each fold and the remainder of the leaves
one of the two folded leaves is placed in a mould along with the two sections positioned with one end inside the folded ends of the leaf and held by jigs located laterally inside the mould
the second folded leaf is placed over the two sections such that its folded ends cover the other end of the sections and that an internal space is delimited by the two leaves and the two sections
expanded plastic is injected into the said internal space
the panel is extracted from the mould.

By “jigs” is meant any device allowing the sections and leaves to be held in place during injection of the injected material and until extraction of the panel from the mould.

In many cases, the effect of foam injection is to make the various layers adhere to each other. This panel manufacturing method is both simple and quick.

Advantageously, the panel is kept under pressure for a time, depending on its thickness, between the moment of the injection of the expanded plastic and its extraction from the mould, in particular to ensure proper adhesion between the various structural components and to stabilize its dimensions during the injected-polyol reaction time.

The leaves used in the process according to this alternative implementation of the invention are usually obtained by extrusion in the case of plastic leaves.

Folding of the plastic and/or metal leaf ends parallel to the panel length can be performed by any suitable method, either in line with their extrusion or off-line. Folding is advantageously performed using a roller folding machine, a device known to those skilled in the art both in plastics technology and metallurgy.

In general, the folding angle is greater than or equal to 95°, preferably 100° and even 110°. The length of the folded edge is preferably greater than or equal to 3 mm, even 5 mm, but less than or equal to 10 mm, even 8 mm.

In this alternative implementation of the invention, the integrated panel assembly system may be produced by any known implementation method (moulding, overmoulding, thermoforming, compression moulding, extrusion, etc.). In particular, it is advantageously manufactured by extrusion when it is made up of sections. If the sections feature additional periodic patterns such as notches or protuberances arranged at regular spacing, the extrusion die will be fitted with a moving device actuated periodically. In an advantageous alternative implementation (in particular due to its simplicity and cost), identical extruded sections are used. In a particularly advantageous alternative implementation, these sections feature at each of their ends (bottom and/or top, when the section is viewed in cross section through a plane perpendicular to its extrusion axis) a “folded” part of shape suitable for interlocking with the folded edges of the leaf. This folded part can be produced during section extrusion or be obtained by thermoforming, (over)moulding, folding, etc. the section edge after extrusion.

An advantage of this process involves the fact of being able to adjust easily the length of the trapezium base and thus of being able to control the size of the seal when assembling the panels. In the case of seals injected after assembly, a large enough space is in fact required to be able to inject the said seal, but it must not be too large to avoid wasting sealant. These parameters can vary depending on the operator, the type of panels, the sealants, etc. A practical way of encouraging this variability involves adjusting the gap between the sections and the leaf folds prior to injecting expanded plastic.

The present invention also concerns a process for assembling insulating panels as previously described, according to which two of these panels are assembled such that they delimit with their assembly system at least one cavity widening towards the inside of the panel and according to which a seal is then introduced into this cavity.

The seal can be a seal produced before assembling the panels and inserted between them during the said assembly. Preferably, its shape is then such that it widens towards the inside of the panel and mates preferably with the cavity walls. However, the seal is advantageously injected or overmoulded in the cavity after assembling the panels. Most particularly preferably, care is taken to completely fill the cavity with sealant to leave the least possible number of voids. The sealant can be made of any material preferably possessing elastomeric properties. A silicone sealant gives good results.

An advantage of this process involves producing an assembled structure, which depending on a suitable choice of materials, is impermeable and fire resistant over its entire external surface area, without insulation loss where one panel has been assembled with another.

Finally, the invention also concerns the use of a panel according to the invention as defined hereabove, in particular as an insulating lining or insulating self-standing structural wall for the storage of animal feeds or the construction of shelters.

Thus, these panels can, for example, be used for a wide range of applications such as: construction of refrigerated warehouses, cold rooms and/or animal feed storage facilities; construction of hospital operating theatres; production of goods vehicle bodies; insulation of swimming pools; construction of lightweight low-cost dwellings, various shelters, etc.

Moreover, the panels according to the invention are also advantageously used for storing animal feeds, building cowsheds, etc. and, in particular, when these are insulating multilayer panels (in an advantageous embodiment detailed hereabove) preferably made of plastic and most particularly preferably made of a rigid PVC/PUR foam/rigid PVC combination. The excellent insulation properties, both thermal and acoustic, the sealing capacity, the corrosion resistance, the ease of assembly (and disassembly) and finally the economic character of the panels according to this alternative to the invention permit particularly competitive usage in these applications. Furthermore, the assembly system ensures that the panels according to the invention preserve these properties during a long period of usage.

Another advantageous field of application for the panels according to the invention involves manufacturing temporary shelters, sick bays, etc. in refugee camps for example. In particular, these panels can form the walls of an emergency package-delivered shelter as described in application WO 02/061216. In this case, the said walls are arranged on a transport pallet, which will be used as a floor in the shelter. Again in this case, the alternative comprising insulting multilayer panels, preferably made of plastic (most particularly preferably made of rigid PVC/PUR foam/rigid PVC combination) is particularly advantageous.

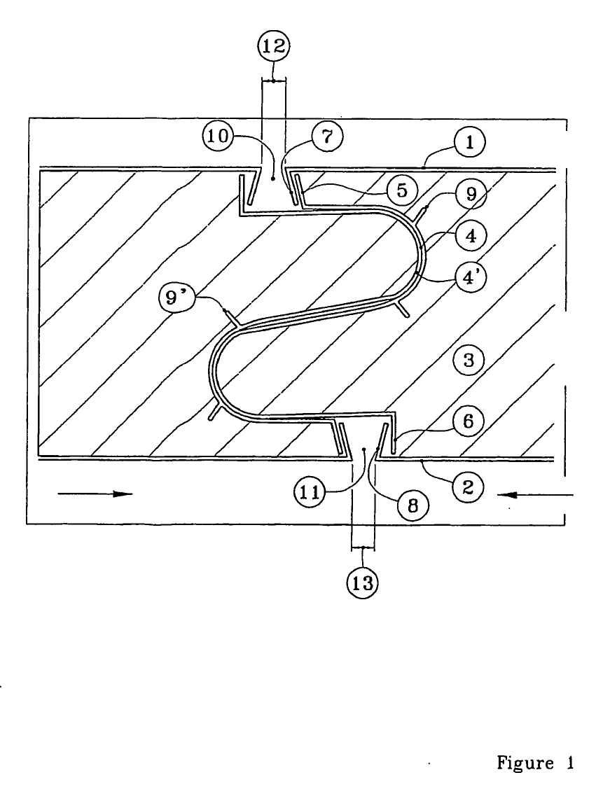

The present invention is illustrated without limitation by FIG. 1, which represents (in cross section) an example of two panels assembled according to the invention.

These panels are identical and each comprise two rigid PVC leaves (1) (2) enclosing a PUR foam core (3) and two assembly sections located at each of their ends extending the full length of the panels (dimension perpendicular to the cross section), one of which is represented by panel (4 and 4′). The PUR foam (3) adhering to both the leaves (1) (2) and the section (4) ensures cohesion of the unit.

The sections (4 and 4′) are made of rigid PVC and are identical, but shaped such that they are interlockable. They each include two folded ends (5 and 6) suitably shaped to fit into two longitudinal folded ends (7 and 8) of the leaves (1) (2). They also each include stiffening ribs (9 and 9′).

In the alternative embodiment represented, the left-hand and right-hand panels are assembled by straightforward translation parallel to their respective surfaces (in the direction of the arrows) so as to delimit two trapezoidal cavities (10 and 11). The base length of these cavities (12 et 13) and therefore the size of the seals (not represented) is adjustable due to the positioning on the press table and the possibility of increasing or decreasing the play between points 6 and 8.

In this figure, it can also be seen that the shape of the sections and the fact that they are flexible allows a degree of torsion between them, which enables, in particular, play to be maintained at some points (even around the centre of the S), thereby facilitating assembly of the panels and possibly even of an arched structure.

1-10. (canceled)

11. A multilayer insulating panel comprising:
an injected/foamed plastic core incorporated between two layers of non-expanded material; and
an integrated assembly system allowing the panel and at least one other complementary panel to be assembled in at least one dimension in space,
wherein the panel and its assembly system are of a form that, when the panel and complementary panel are assembled, they delimit with their assembly system at least one adjustable cavity configured for injecting a seal, the cavity widening at least partly towards the inside of the panel.

12. A multilayer insulating panel according to claim 11, mainly made of plastic.

13. A multilayer insulating panel according to claim 12, wherein the expanded plastic core is made of polyurethane and the two layers of non-expanded plastic are made of rigid PVC.

14. A multilayer insulating panel according to claim 11, wherein the assembly system includes two identical plastic sections located on either side of the panel in a lengthwise direction.

15. A multilayer insulating panel according to claim 11, wherein once they have been assembled, the two complementary panels and their assembly systems delimit two cavities, one on each face of the assembly.

16. A process for manufacturing an insulating panel according to claim 11, wherein an insulating panel of desired shape is manufactured and an assembly system, also of desired shape, is fixed to the panel to obtain at least one cavity widening towards the inside of the panel once the panel is assembled with the complementary panel, the cavity being adjustable and configured for injecting a seal and the panel being manufactured by injecting/foaming an expanded plastic core between two layers of non-expanded plastic.

17. A process according to the claim 16, including:
two non-expanded plastic or metal leaves are manufactured along with two complementary plastic sections of the same length as the leaves and the panel, featuring a folded section at each of their ends;
two ends of the two leaves parallel to the panel length are folded so as to obtain an acute angle between each fold and the remainder of the leaves;
one of the two folded leaves is placed in a mold along with the two sections positioned with one end inside the folded ends of the leaf and held by jigs located laterally inside the mold;
the second folded leaf is placed over the two sections such that its folded ends cover the other end of the sections and that an internal space is delimited by the two leaves and the two sections;
expanded plastic is injected into the said internal space; and
the panel is extracted from the mold.

18. A process according to claim 17, wherein the leaves are folded using a roller folding machine.

19. A process for assembling insulating panels according to claim 11, according to which two complementary multilayer panels with an injected/foamed plastic core incorporated between two layers of non-expanded material are assembled such that they delimit with their assembly system at least one adjustable cavity widening towards the inside of the panel and according to which a sealant is then injected into this cavity.

20. Use of insulating panels according to claim 11 as an insulating lining or insulating self-standing structural wall for the storage of animal feeds or the construction of shelters.
